(19) United States
(12) Patent Application Publication
(10) Pub. No.: US 2004/0169994 A1
(43) Pub. Date: Sep. 2, 2004

(54) Portable computer unit

(76) Inventors: Janos-Gerold Enderlein, Berlin (DE); Ralf Wendler, Berlin (DE)

Correspondence Address: MORRISON & FOERSTER LLP, 1650 TYSONS BOULEVARD, SUITE 300, MCLEAN, VA, 22102, US

(21) Appl. No.: 10/474,683

(22) PCT Filed: Mar. 21, 2002
(86) PCT No.: PCT/DE02/01078

(30) Foreign Application Priority Data
Apr. 12, 2001 (DE) 101 19 531.1

(51) Int. Cl. G06F 1/16

(52) U.S. Cl. 361/683

(57) ABSTRACT

The invention relates to a portable computer unit, in particular a PDA, with an integrated radio unit, at least one antenna and a housing for the radio unit with a lower housing piece and a cover, whereby the at least one antenna is integrated in the housing.

The present invention relates to a mobile computer unit, in particular a Personal Digital Assistant (PDA). PDAs with an integrated radio module require an antenna which, until now, has been in the form of an external antenna. Until now, the antenna has been rigidly connected to the housing of the PDA and has projected out of the housing, generally on the upper face of the housing. Since a keyboard is normally used to make inputs when using a PDA, the PDA is at this time preferably flat on a base, such as a table. This is the commonest operating position for a PDA. However, an antenna (which is essential for PDAs with an integrated radio module) is often very inefficient in this position.

On the one hand, the base or the working surface on which the PDA is located may have an absorbent, reflective and/or distorting effect on the antenna field, depending on its characteristics, and this can result in poor radio transmission.

On the other hand, the antenna, which generally projects from the face of the housing, is (when the PDA is in the commonest operating position as mentioned) located only a very short distance away, parallel to the working surface or the base underneath the PDA. This could result in very poor antenna efficiency, caused mainly by mistuning of the resonant frequency of the antenna, thus reducing the range of the radio link and, possibly, also increasing the current drawn by the transmission output stage. Furthermore, this does not result in the antenna having a transmission characteristic in all directions, that is to say it does not result in the antenna having an omnidirectional polar diagram. Only an omnidirectional polar diagram, for example that of a dipole, offers the capability to receive all base stations on a direct path from different directions equally well. An antenna which is pointing parallel to the table surface transmits largely upwards and downwards.

One object of the invention was to provide a mobile computer unit having an antenna, with the antenna having as high an efficiency as possible and having an improved polar diagram when used in the typical manner.

This object was achieved by a mobile computer unit according to the invention as claimed in claim 1. Advantageous embodiments are described in the respective corresponding dependent claims.

According to claim 1, a mobile computer unit is provided, in particular a Personal Digital Assistant (PDA). The computer unit contains an integrated radio unit, at least one antenna and a housing for holding the radio unit with a housing lower part and a cover, with the antenna being integrated in the housing.

For the purposes of the present invention, the expression integration of the antenna in the housing of the mobile computer unit means that, on the basis of the external appearance of the computer unit, the antenna forms a unit with the housing, that is to say the antenna is not proud of the housing, nor does it project out of the housing. However, for example, the antenna may either be arranged within the housing or else may be fitted to it, for example being adhesively bonded to it.

The antenna is preferably integrated in the cover of the housing. The cover of the mobile computer unit, preferably of the PDA, is folded out when using the mobile computer unit, as a result of which the antenna that is preferably integrated in the cover is in a vertical position and can thus achieve high efficiency. It is thus at the maximum possible distance from the working surface or base, and is thus subjected only to a minor extent to the absorbent, reflective and/or distorting effects of the base on the antenna field. Furthermore, when in the vertical position, it has an omnidirectional polar diagram, that is to say it can transmit in all directions from this vertical position. Suitable mechanical stops are preferably provided, with the aid of which the cover can be fixed in the best position for antenna efficiency during use of the mobile computer unit.

The cover is preferably connected to the PDA radio unit via electrical radio-frequency lines. The cover is preferably mechanically attached to the housing lower part by means of one or more hinges which are arranged in a suitable manner, preferably on the sides of the cover and/or on the housing lower part of the mobile computer unit, preferably of the PDA. In one particularly preferred embodiment of the mobile computer unit, preferably of the PDA, according to the invention, at least one of the hinges which mechanically connects the cover to the housing lower part is in the form of an electrical radio-frequency line. This preferably once again comprises interacting coaxial plugs and corresponding coaxial sockets. This offers a low-loss, completely shielded feed line for the antenna. Furthermore, the electrical connection may also be a coaxial radio-frequency line or a planar radio-frequency line formed from a flexible printed circuit material. In this case, there is no need for any mechanical contact point, that is subject to wear, thus improving the reliability of the contact with the antenna.

In another preferred embodiment of the mobile computer unit according to the invention, the antenna is in the form of a printed structure, which can be produced using a single-layer or multilayer technique. Large-area antennas allow broadband antennas to be produced, for example patch antennas, spiral antennas or fractal antennas, which are less sensitive to external influences. Monoband or multiband antennas can be integrated in the form of dipoles in an extended meandering, spiral or angled shape. An antenna embodiment such as this is cost-effective, and can be produced easily.

A further advantage of the present invention is that the integrated antenna cannot be seen from the outside when it is integrated into the housing of the mobile computer unit, thus offering a very good capability for integration in the design of the overall computer unit, that is to say, when choosing the design, there is no need to take account of the antenna in the external appearance of the computer unit. Furthermore, the antenna is not a unit representing an obstruction that projects from the side of the housing.

In a further preferred embodiment of the mobile computer unit according to the invention, two or more antennas are provided. It is thus very easily possible to cover two or more frequency bands and/or two or more broadband frequency ranges at the same time. Furthermore, the antenna may have two or more radiating structures, thus providing a multiband antenna with more than two bands. The overall dimensions of the antenna may in this case vary from matching to different requirements. The structure of the antenna is preferably designed for space optimization, matched to the respective mobile computer unit.

There are a number of possible ways to produce the antenna. First of all, the antenna according to the invention can be produced on a PCB (printed circuit board). Furthermore, it can be produced from a metal sheet by means of a stamping and bending technique, or may be in the form of a metalized sheet. This is done, for example, in this case by using flexible plastic material which can be bent, in particular a sheet of polycarbonate or polyetherimide. A conductor track can be structured one each layer, representing an antenna element or any other desired electrical element. The structuring can be produced by means of various technologies, known from the selective structuring for so-called MID applications. In particular, metalization of the entire area followed by laser structuring, the application of a primary lacquer for metalization by mask coverage or tampon printing (Boymetec method) and subsequent metalization may be mentioned in this case. The expression metalization in this case means chemical deposition and/or electrochemical deposition of metals. A further variant is, for example, the printing of a conductive varnish by template, tampon or screen printing.

Finally, the antenna according to the invention may be designed using the MID technique (molded interconnected device). The material on which the structure is applied in the case of the PCB and the MID technique can be chosen without any restrictions, but is preferably compatible with radio frequencies. It may also be a flexible material which can be bent, thus allowing matching to housing and/or appliance contours.

Further advantages of the mobile computer unit according to the invention will be described with reference to the following figure, in which:

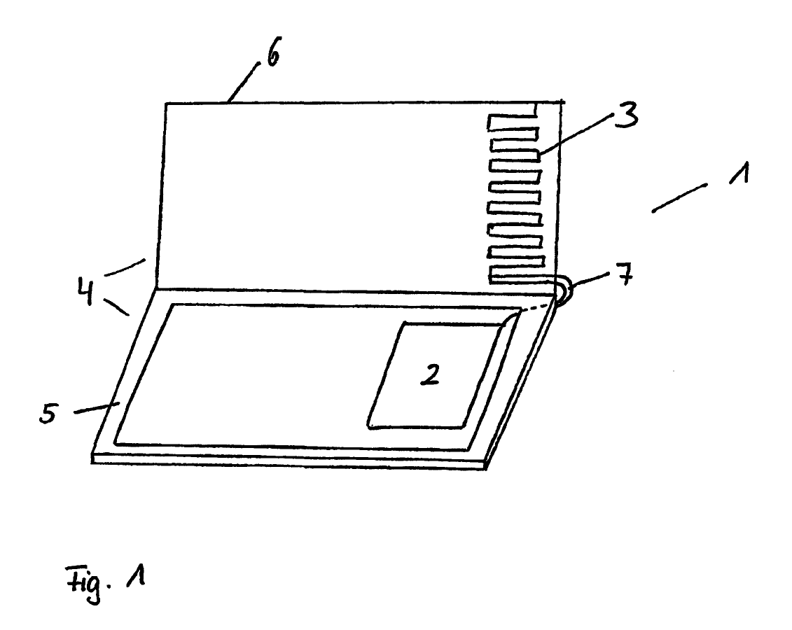

FIG. 1 shows a schematic illustration of one embodiment of a mobile computer unit according to the invention.

FIG. 1 shows a mobile computer unit 1, which is preferably a Personal Digital Assistant (PDA). The mobile computer unit 1 has an integrated radio unit 2, an antenna 3 and a housing 4 for holding the radio unit 2. The housing 4 in turn has a housing lower part 5 and a cover 6. The housing lower part 5 in this case holds the radio unit 2. The antenna 3 is integrated in the cover 6. The antenna 3 may in this case be arranged within the cover 6, or may be fitted on the cover 6. In the present example, the antenna 3 has a meandering shape. The cover 6 is mechanically connected to the housing lower part 5 by means of at least one hinge 7. The at least one hinge 7 is preferably in the form of an electrical radio-frequency line, preferably a coaxial radio-frequency line. This ensures a low-loss, completely shielded feed line for the antenna 3.

The at least one hinge 7 is preferably designed such that the cover 6 can be fixed in the best position for antenna efficiency during use of the mobile computer unit 1.

1. A mobile computer unit (1), in particular a Personal Digital Assistant (PDA), having an integrated radio unit (2), at least one antenna (3) and a housing (4) for holding the radio unit (2) with a housing lower part (5) and a cover (6),
characterized
in that the at least one antenna (3) is integrated in the housing (4).

2. The mobile computer unit (1), in particular a PDA as claimed in claim 1,
characterized
in that the antenna (3) is integrated in the cover (6) of the housing (4).

3. The mobile computer unit (1), in particular a PDA, as claimed in claim 2,
characterized
in that the cover (6) is connected via electrical radio-frequency lines to the radio unit (2) of the mobile computer unit (1).

4. The mobile computer unit (1), in particular a PDA, as claimed in claim 3,
characterized
in that at least one hinge (7), which mechanically connects the cover (6) to the housing lower part (5), is in the form of an electrical radio-frequency line, in particular a coaxial radio-frequency line.

5. The mobile computer unit (1), in particular a PDA, as claimed in one of the preceding claims,
characterized
in that the antenna (3) is in the form of a printed structure.
